(19) United States
(12) Patent Application Publication
(10) Pub. No.: US 2011/0302905 A1
(43) Pub. Date: Dec. 15, 2011

(54) EYEBALL SEALS FOR GIMBALED ROCKET ENGINES, AND ASSOCIATED SYSTEMS AND METHODS

(75) Inventors: Erich K. Weinberg, Kent, WA (US); Beth A. Mikulka, Seattle, WA (US); Kip Carver, Mountlake Terrace, WA (US)

(73) Assignee: Blue Origin, LLC, Kent, WA (US)

(21) Appl. No.: 12/815,288

(22) Filed: Jun. 14, 2010

Related U.S. Application Data
(60) Provisional application No. 61/187,259, filed on Jun. 15, 2009.

(51) Int. Cl. F02K 1/80; F16J 15/16

(52) U.S. Cl. 60/204; 277/345; 277/507; 60/770

(57) ABSTRACT

Eyeball seals for a gimbaled rocket engines, and associated systems and methods are disclosed. A system in accordance with a particular embodiment includes a rocket body, an engine carried by and movable relative to the rocket body, and a seal assembly. The seal assembly can include a sealing surface carried by one of the rocket body and the engine, and a seal element carried by the other of the rocket body and the engine. The seal element is in contact with the sealing surface. The seal assembly can further include a cylinder and a piston slideably received in the cylinder, with one of the piston and the cylinder carrying the seal element. The cylinder includes ports that are in fluid communication with a region external to the rocket body. Accordingly, pressures external to the rocket body can force the seal element and/or the sealing surface into contact with each other.

### CROSS-REFERENCE TO RELATED APPLICATION

The present application claims priority to pending U.S. Provisional Application No. 61/187,259, filed Jun. 15, 2009 and incorporated herein by reference.

### TECHNICAL FIELD

The present disclosure is directed generally to eyeball seals for gimbaled rocket engines, and associated systems and methods.

### BACKGROUND

Rockets have been used for many years to launch human and non-human payloads into orbit. Such rockets delivered the first humans to space and to the moon, and have launched countless satellites into the earth's orbit and beyond. Such rockets are used to propel unmanned space probes and more recently to deliver structures, supplies, and personnel to the orbiting international space station.

One continual challenge associated with rocket missions is providing sufficient control authority during all phases of rocket operations. One approach to addressing this challenge is to provide the rocket with gimbaled rocket engines that can change the direction in which they direct rocket thrust, so as to stabilize and/or redirect the rocket. One challenge associated with gimbaled rocket engines is to properly seal the interface between the engine and the rocket, despite the movement of the engine relative to the rocket. Aspects of the present disclosure are directed to addressing this challenge.

### BRIEF DESCRIPTION OF THE DRAWINGS

FIG. 1 illustrates a representative vehicle having gimbaled rocket engines in accordance with an embodiment of the disclosure.

FIG. 2 is a partially schematic, bottom isometric illustration of a portion of the vehicle shown in FIG. 1.

FIG. 3 is a top isometric view of an engine having a sealing surface configured in accordance with an embodiment of the disclosure.

FIG. 4 is a partially schematic top isometric view of a heat shield and seal assembly configured to receive an engine in accordance with an embodiment of the disclosure.

FIG. 5 is a top isometric view of a seal assembly having a support configured in accordance with an embodiment of the disclosure.

FIG. 6 is a side isometric view of a seal element configured in accordance with an embodiment of the disclosure.

FIG. 7 is a partially schematic, cut-away illustration of a seal assembly configured in accordance with an embodiment of the disclosure.

FIG. 8 illustrates a cross-sectional view of a seal assembly configured in accordance with an embodiment of the disclosure.

FIG. 9 is a partially schematic, cross-sectional illustration of a seal assembly manufactured and installed in accordance with an embodiment of the disclosure.

FIG. 10 is an exploded isometric illustration of a portion of the seal assembly shown in FIG. 9.

### DETAILED DESCRIPTION

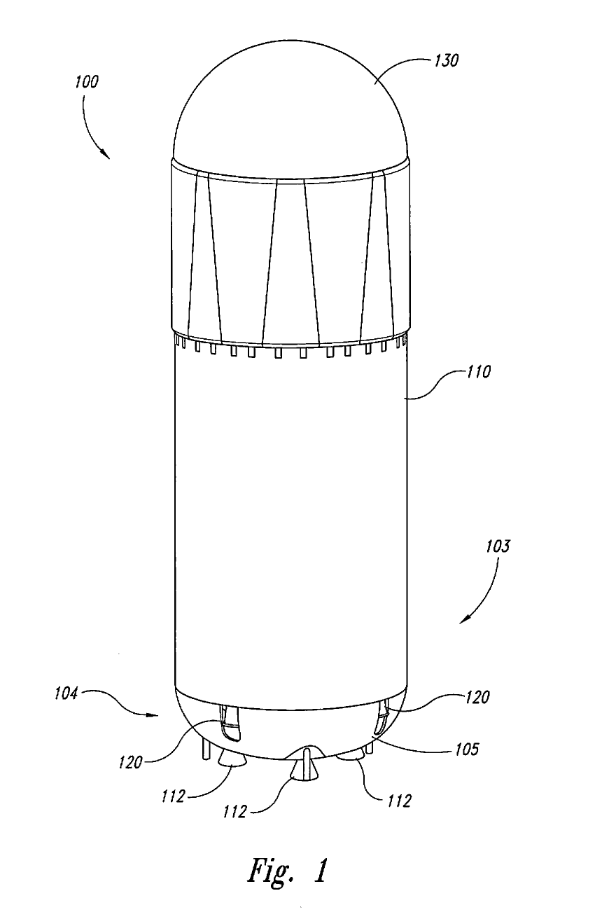

The present disclosure is directed generally to eyeball seals for gimbaled rocket engines, and associated systems and methods. In particular embodiments, the seal can include a piston/cylinder arrangement that utilizes the pressure difference between the environment external to the rocket and the environment internal to the rocket to provide and/or enhance the forces forming the seal. Several details describing structures and processes that are well-known and often associated with such seals are not set forth in the following description to avoid obscuring other aspects of the disclosure. Moreover, although the following disclosure sets forth several embodiments, several other embodiments can have different configurations, arrangements, and/or components than those described in this section. In particular, other embodiments may have additional elements, and/or may lack one or more of the elements described below with reference to FIGS. 1-10.

FIG. 1 is a top isometric illustration of a vehicle 100 configured in accordance with an embodiment of the disclosure. The vehicle 100 can be a rocket (e.g., an orbital or suborbital vehicle) that includes a propulsion module 110 carrying a payload module 130. The propulsion module 110 can include one or more engines having corresponding engine exhaust nozzles 112 positioned at an aft portion 103 of the vehicle 100. The vehicle 100 can include landing gear 120 positioned to allow the vehicle 100 to land in a tail-down orientation. Fins (not shown in FIG. 1) toward the aft portion 103 of the vehicle 100 can act as stabilizers and/or control surfaces during ascent, and can also act as stabilizers and/or control surfaces during descent.

In a particular embodiment, the payload module 130 can be configured to carry cargo and/or crew. In an embodiment shown in FIG. 1, the payload module 130 can have a hemispherical shape and in other embodiments, the payload module 130 can have other shapes.

In a particular embodiment shown in FIG. 1, the vehicle 100 includes five engines, each having a corresponding engine exhaust nozzle 112 that projects outwardly through a heat shield 105 at a lower surface 104 of the vehicle 100. The heat shield 105 protects the vehicle 100 from high temperatures associated with engine exhaust gas products encountered during engine operation, and/or aerodynamic friction encountered during high speed descent. The engines are used during the boost phase to propel the vehicle 100 upwardly. The engines can also provide thrust vectoring to steer the vehicle 100 during one or more phases of a mission (e.g., during the boost phase and/or the landing phase), alone or in combination with other control systems (e.g., the fins). Accordingly, the exhaust nozzles 112 can gimbal so as to direct thrust in a manner that stabilizes and/or steers the vehicle 100. During a representative mission, the engines and/or the fins can be used to control and steer the vehicle directly back to the site from which it was launched. In other embodiments, the vehicle 100 can be steered to other sites. In any of these embodiments, as the vehicle 100 approaches the landing site, the engines can be used to slow the vehicle 100 down and to steer/stabilize the vehicle 100. The landing gear 120 are then deployed for final touchdown.

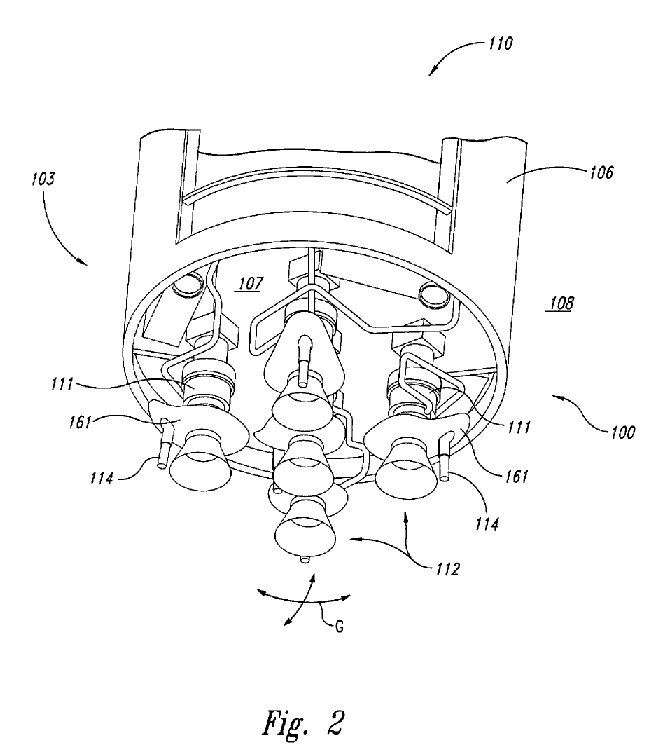

FIG. 2 is a bottom isometric illustration of the aft or lower portion 103 of the propulsion module 110 described above with reference to FIG. 1. For purposes of illustration, the heat shield 105 described above with reference to FIG. 1 has been removed in the illustration shown in FIG. 2. The propulsion module 110 includes a casing 106 that separates an external region 108 outside the vehicle 100 from an internal region 107 within the vehicle 100. The propulsion module 110 contains one or more engines 111 (five are shown in FIG. 2), each having a corresponding exhaust nozzle 112. In a particular aspect of an embodiment shown in FIG. 2, each engine 111 also includes one or more turbo pumps that provide fuel and/or oxidant for combustion. Exhaust products from the turbo pumps are directed through turbo pump exhausts 114 positioned alongside the nozzles 112. Each of the engines 111 can gimbal in multiple directions (as indicated by arrows G) about a corresponding pivot point so as to provide for thrust vectoring. Accordingly, each engine 111 can include a sealing surface 161 (e.g., a rigid sealing surface) having a spherical or otherwise curved shape that is used to maintain a seal or partial seal between the internal region 107 and the external region 108 even as the engines 111 gimbal relative to the casing 106. As used herein, the term seal refers generally to structures and methods that prevent and/or at least significantly restrict the passage of gases over a range of pressures and temperatures.

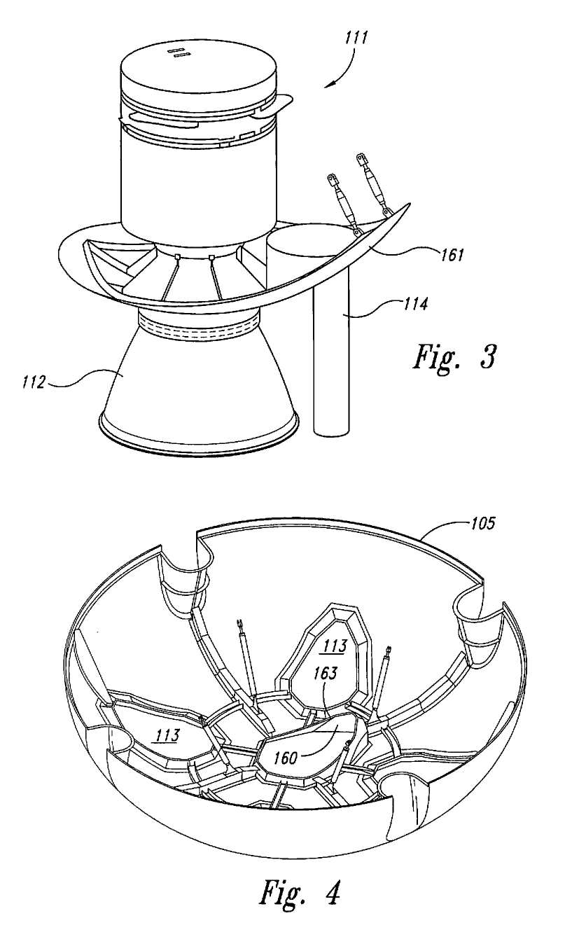

FIG. 3 is a partially schematic, top isometric view of a single one of the engines 111 initially described above with reference to FIG. 2. FIG. 3 further illustrates the nozzle 112 and the turbo pump exhaust 114 that project downwardly through and away from the sealing surface 161. In a particular embodiment, the sealing surface 161 is spherical or generally spherical, with a center of curvature located at or approximately at the pivot point about which the engine 111 gimbals. In other embodiments, the sealing surface 161 can have other shapes, e.g. other curved shapes that facilitate sealing despite the motion of the engine 111.

FIG. 4 is a partially schematic, top isometric illustration of the heat shield 105 initially described above with reference to FIG. 1. Referring now to FIGS. 3 and 4 together, the heat shield 105 can include multiple nozzle openings 113, each sized to receive a corresponding nozzle 112. The heat shield 105 can carry one or more seal assemblies 160 positioned around the corresponding nozzle openings 113 so as to provide a dynamic seal with the engine 111. For example, an individual seal assembly 160 can include an upwardly facing seal element 163 (e.g., a flexible seal element) that engages with the downwardly facing sealing surface 161 carried by the engine 111 to provide a seal or partial seal as the engine 111 moves relative to the heat shield 105. The nozzle openings 113 are sized to accommodate the motion of the engines 111, along with a tolerance margin. In a particular embodiment shown in FIGS. 3 and 4, the nozzle openings 113 are asymmetric relative to at least one axis to account for the asymmetric shape presented by the combination of the nozzle 112 and the turbo pump exhaust 114. In other embodiments, the nozzle opening 113 can have other asymmetric shapes and/or symmetric shapes, depending upon the arrangement of the nozzle 112 and/or associated hardware projecting through the nozzle opening 113.

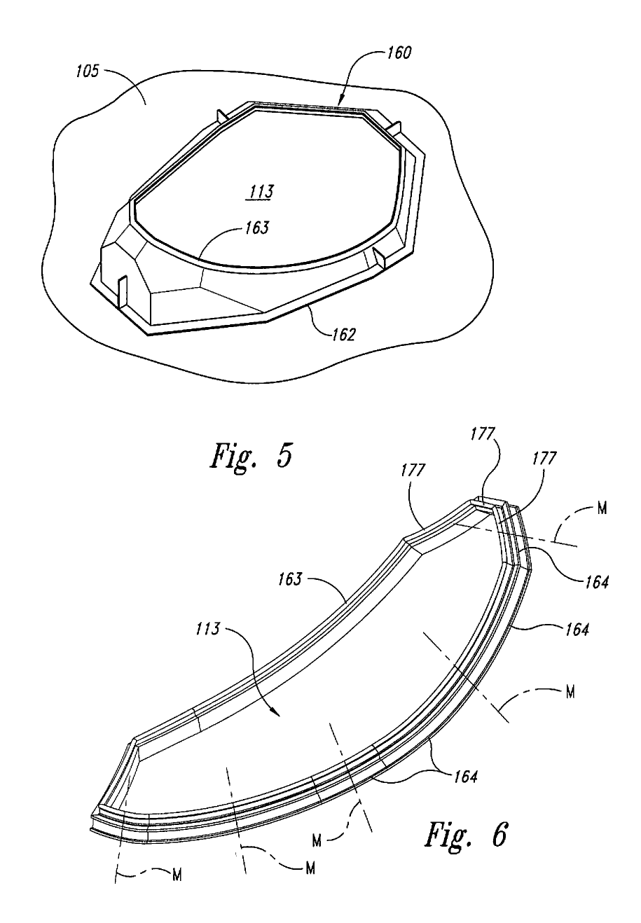

FIG. 5 is a top isometric illustration of a portion of the heat shield 105 and a representative seal assembly 160 configured in accordance with an embodiment of the disclosure. The seal assembly 160 can include a support 162 that is carried by and attached to the heat shield 105 or other fixed rocket structure, and that in turn supports the seal element 163. In a particular aspect of this embodiment, the seal element 163 is movable relative to the support 162 and the heat shield 105 so as to enhance its ability to seal against the engine sealing surface 161 (FIG. 3).

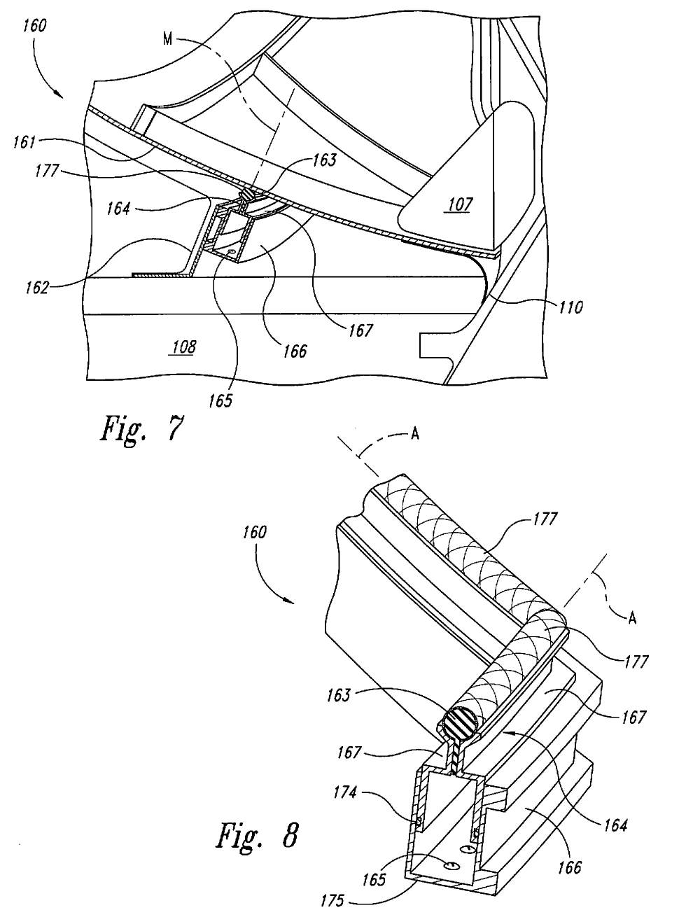

FIG. 6 is a partially schematic, side view of the seal element 163 shown in FIG. 5. In a particular aspect of this embodiment, the seal element 163 can be a continuous element forming a closed shape that extends around the nozzle opening 113. Although the seal element 163 can be continuous, it can include multiple adjoining segments 177 that may form corners where they intersect. Each of these segments 177 can be shaped in a manner that corresponds to the curved line resulting from the intersection between a plane (e.g., a flat plane) and the curved sealing surface 161 shown in FIG. 3. Accordingly, each of the segments 177 can have a concave shape when viewed from above. Each segment 177 can also be supported by a corresponding seal holder 164. In a particular aspect of this embodiment, neighboring seal holders 164 can be separated from each other by a corresponding gap (not visible in FIG. 6) to allow neighboring seal holders 164 to move relative to each other, as indicated by representative motion axes M. Because neighboring seal holders 164 can be separated from each other, they can move along non-parallel motion axes M as shown in FIG. 6, without binding. For example, the motion axes M can converge at the center of curvature of the sealing surface 161 (FIG. 3). While the amount of motion each seal holder 164 undergoes may be relatively small, the ability of individual seal holders 164 to move relative to each other can improve the efficacy of the seal between the seal element 163 and the sealing surface 161 (FIG. 3), as described further below with reference to FIGS. 7-10.

FIG. 7 is a partially schematic, cross-sectional illustration of a portion of a representative sealing assembly 160, configured in accordance with a particular embodiment of the disclosure. As shown in FIG. 7, the upwardly facing seal element 163 is in contact with the downwardly facing sealing surface 161 carried by the corresponding engine 111 (FIG. 3). An individual segment 177 of the seal element 163 is attached to a corresponding holder 164, which is in turn carried by a piston or plunger 167. The piston 167 can move toward and away from the sealing surface 161 along the motion axis M. Accordingly, the piston 167 is slideably positioned within a corresponding cavity or chamber (e.g., a cylinder 166), which guides the motion of the piston 167.

The cylinder 166 can have a generally rectangular cross-sectional shape (when intersected by a plane generally normal to the motion axis M) in at least some embodiments, e.g., to receive a piston 167 having a corresponding rectangular cross-sectional shape. In other embodiments, the cylinder 166 and the piston 167 can have other corresponding cross-sectional shapes. The cylinder 166 is carried by (e.g., attached to) the support 162, which is in turn carried by (e.g., attached to) the structure of the propulsion module 110. A lower portion of the cylinder 166 includes one or more ports 165 that provide fluid communication between the interior of the cylinder 166 and the external region 108 outside the propulsion module 110. Accordingly, when the pressure in the external region 108 exceeds the pressure in the internal region 107, the cylinder 166 is pressurized, which drives the piston 167 and the seal element 163 into sealing engagement with the sealing surface 161.

FIG. 8 is a partially schematic, isometric illustration of multiple portions of the seal assembly 160 described above with reference to FIG. 7. The seal element 163 can include a closed loop (a portion of which is visible) that is initially manufactured as a continuous member, or that is made up of individual segments 177 that are then joined together. In a particular embodiment, the seal element 163 can include a nickel alloy wire braid wrapped over one or more ceramic fiber elements. Accordingly, the seal element 163 can provide a gas-tight or semi gas-tight seal when positioned against the corresponding sealing surface 161 (FIG. 7), while withstanding the high temperatures associated with the region around the exhaust nozzles 112 (FIG. 2). In other embodiments, the seal element 163 can include other high-temperature materials having sufficient flexibility to form a gas-tight or semi gas-tight seal.

Individual seal holders 164 can have an upwardly facing cup shape that receives the seal element 163 and clamps around the seal element 163 to keep it in position. Individual seal holders 164 can be elongated along a corresponding axis A, and can be bowed (e.g., dished generally downwardly in the view shown in FIG. 8) so as to shape the seal element 163 in a manner that corresponds at least generally to the curvature of the sealing surface 161 (FIG. 7). The seal holder 164 depends from (and can be integral with) the piston 167. The piston 167 can include a piston seal 174 that slideably bears against the inwardly facing walls of the cylinder 166 to seal or at least partially seal the piston 167 within the cylinder 166. Accordingly, when the cylinder 166 is pressurized via the ports 165, the piston 167 and the flexible seal 163 are forced upwardly against the sealing surface 161. As shown in FIG. 8, the cylinder 166 can be formed from channel stock 175 or another suitable pre-formed or custom-formed material.

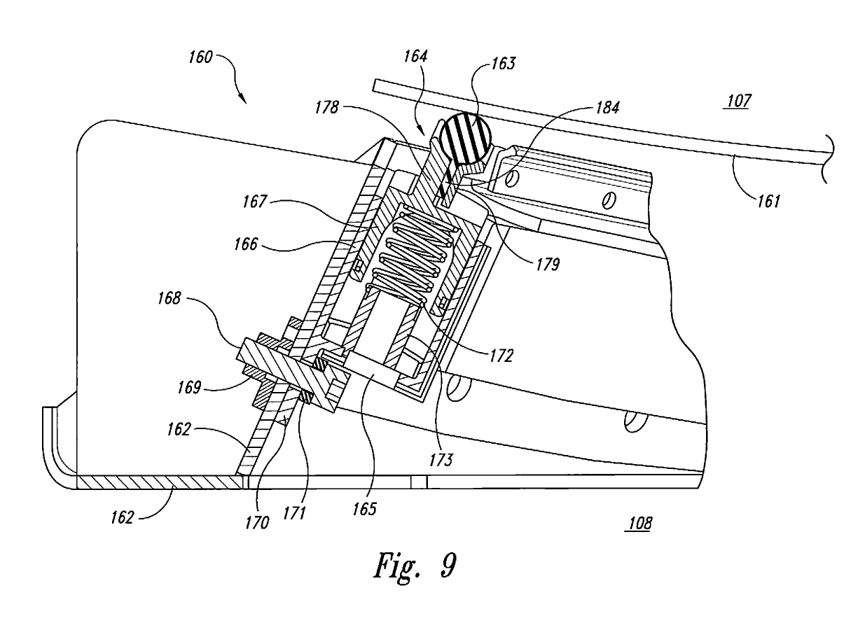

FIG. 9 is a partially schematic, cut-away illustration of a seal assembly 160 illustrating further details in accordance with a particular embodiment of the disclosure. As shown in FIG. 9, the holder 164 can include a first portion 178 and a second portion 179. The first portion 178 can be integrally formed with the piston 167, or it can be attached to the piston 167 using a suitable attachment technique (e.g., fasteners or welding). The second portion 179 of the holder 164 clamps the seal element 163 firmly against the first portion 178. For example, the seal element 163 can include a downwardly extending projection 184 that is clamped between the first portion 178 and the second portion 179 of the seal holder 164. The seal assembly 160 can further include a spring 172 positioned between the piston 167 and a spring seat 173 carried by the lower surface of the cylinder 166. Accordingly, the spring 172 can force the piston 167 and the seal element 163 upwardly against the sealing surface 161, for example, when the pressure in the external region 108 does not exceed the pressure in the internal region 107. The cylinder 166 can include a flange 170 that is attached to the support 162 with corresponding sets of bolts 168, nut plates 169 and lock washers 171.

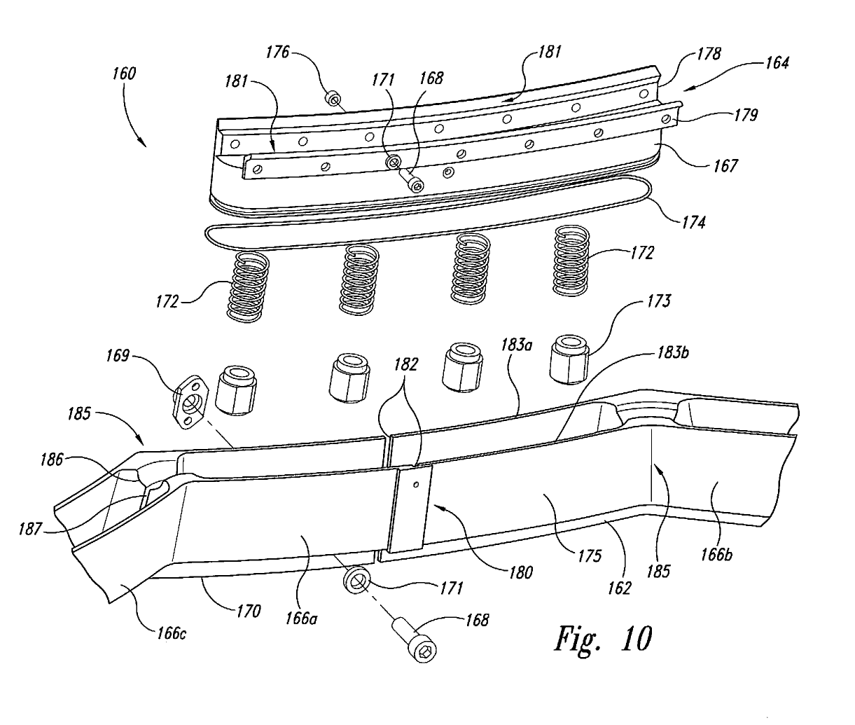

FIG. 10 is an exploded isometric view of a portion of the seal assembly 160, illustrating several of the components described above with reference to FIG. 9. Referring to FIG. 10, the seal assembly 160 can include multiple cylinders 166, three of which are shown in FIG. 10 as first, second and third cylinders 160a, 160b, 160c, each of which receives a corresponding piston 167 (one of which is shown in FIG. 10). Any of the cylinders (e.g., the first cylinder 166a shown in FIG. 10) can include thermal expansion slots 182 and/or other thermal expansion features that can prevent the walls of the cylinder from buckling when exposed to high temperatures. A first wall 183a of the first cylinder 166a can be positioned adjacent to the support 162 shown in FIG. 9, which can at least partially seal the expansion slot 182 in the first wall 183a. The expansion slot 182 in an oppositely facing second wall 183b can be sealed or partially sealed with a stove pipe joint 180 or other suitable sealing technique.

In any of the foregoing embodiments, the cylinders 166 can be secured to the support 162 with threaded bolts 168, corresponding nut plates 169, corresponding lock washers 171, or other suitable attachment arrangements, as discussed above. The first and second portions 178, 179 of the seal holder 164 can be clamped around the seal element 113 (FIG. 9) using bolts 168, lockwashers 171 and helical inserts 176, or other suitable fasteners. Elements of the seal holder 164 (e.g., the first portion 178 and the second portion 179) can have concave curved upper surfaces 181 that support the seal element 163 (FIG. 9) in a manner that allows the seal element 163 to conform to the convex curvature of the corresponding sealing surface 161 (FIG. 9). The piston 167, which carries the seal holder 164, includes the piston seal 174 which partially or completely seals the piston 167 against the walls of the first cylinder 166a. In a particular embodiment, the piston seal 174 can include a braided ceramic fiber wrapped around a metallic core. In other embodiments, the piston seal 174 can have other arrangements.

In an embodiment shown in FIG. 10, neighboring cylinders 166 can be separated by intermediate portions 185. In these regions, the seal element 163 (FIG. 9) is not carried by a seal holder 164. Accordingly, the intermediate portion 185 can include other features that guide and/or constrain the motion of the seal element 163. These features can include a groove 186 that receives the main portion of the seal element 163, and a projection slot 187 that slideably receives the projection 184 (FIG. 9) of the seal element 163. The projection 184 can be elongated downwardly at the intermediate portion 185 (e.g., to be three times as long as is shown in FIG. 9) so that the projection 184 remains contained in the projection slot 187 even as the seal element 163 moves up and down. In other embodiments, the seal element 163 and/or the intermediate portion 185 can have other suitable arrangements.

The materials and dimensions of the components described above can have any of a variety of suitable characteristics and values, depending upon the particular application. In a representative example, the sealing surface 161 can be formed from a rigid metallic material, and have a radius of curvature of about 30 inches. The seal member 163 can be designed to withstand temperatures of from about 1400° F. to about 2400° F. for short durations, and temperatures of about 1000° F. for more sustained periods of time. The seal between the seal member 163 and the sealing surface 161 can be configured to withstand a pressure differential of from about 10 psig to about 15 psig (cold), and from about 5 psig to about 8 psig (hot). The piston 167 can have a stroke of about 0.75 inches to accommodate the thrust vectoring motion of the engine 111, and the relative motion of the seal assembly components and the engine due to thermal expansion.

One feature of several embodiments of the seal assembly 160 described above is that the seal element 163 can be forced against the corresponding sealing surface 161 under the pressure provided by the environment external to the vehicle 100. For example, as described above, the cylinder 166 in which the piston 167 is slideably positioned can have ports 165 that are open to, or otherwise in fluid communication with, the external region 108 so as to drive the piston 167 and the seal element 163 against the sealing surface 161 when the pressure in the external region 108 exceeds the pressure in the internal region 107 within the rocket body. An advantage of this arrangement is that it can make use of the external pressure to facilitate sealing and can accordingly reduce the requirements for other devices to provide this force. For example, the springs 172 provided in the cylinders 166 can be lighter than they otherwise would be, which can reduce system weight and can reduce the physical wear and friction on the components of the seal assembly 160. In a particular aspect of this embodiment, the springs 172 can be sized to provide a suitable force between the seal element 163 and the sealing surface 161 at conditions for which the external force is insufficient to do so, or at conditions for which the internal pressure exceeds the external pressure (e.g., at the high altitudes associated with the final ascent phase of the vehicle). At such conditions, the spring 172 in many cases may need to exert only enough force to provide thermal protection and need not necessarily provide a gas-tight seal. At other conditions, the pressure in the external region 108 can supply a force sufficient to provide a gas-tight or generally gas-tight seal. For example, during launch and initial ascent, a sufficient external force can be provided by the pressure of the exhaust emanating from the exhaust nozzles 112. During descent and landing, a sufficient external force can be provided by the dynamic pressures resulting from the tail-down attitude of the vehicle 100, particularly as it descends at high (e.g., supersonic) speeds.

From the foregoing, it will be appreciated that specific embodiments of the disclosure have been described herein for purposes of illustration, but that various modifications may be made without deviating from the scope of the disclosure. For example, in a particular embodiment described above, the sealing surface is carried by the engine and the seal element is carried by the propulsion module in which the engine is housed. In another embodiment, this arrangement can be reversed, with the sealing surface carried by the propulsion module, and the seal element carried by the engine. In another example, the relative positions of the piston and cylinder can be reversed. For example, the cylinder can carry the seal element and can be movable relative to a fixed piston. In still further embodiments, devices other than a piston/cylinder combination (e.g., an expandable bladder) can convert pressure external to the rocket into a force that engages the seal element with the sealing surface. The shapes of the apertures through which the engine nozzles project can be different in different embodiments, depending upon the configuration of the nozzle and/or associated hardware that may project through the aperture. The propulsion module may have different numbers of engines and, in particular embodiments, multiple engines may in some cases share the same nozzle opening. In still further embodiments, the vehicle can have more than one propulsion module, for example, more than one stage.

In other embodiments, seal arrangements having characteristics and features generally similar to those described above can be used to seal interfaces between components other than rocket engines and rocket bodies. For example, such seal arrangements may be used to seal interfaces associated with aerodynamic control surfaces. In other embodiments, such seals may be used to seal other interfaces in high temperature, high-vibration environments for which dynamic sealing is beneficial, e.g., a wall through which a rotating shaft passes, which is subject to high temperature and/or vibration, and which separates regions having different pressures. Furthermore, the sealing surfaces against which the seal bears can have non-spherical shapes (e.g., conical, cylinder, and/or other curved shapes) in certain embodiments.

Certain features of the disclosure described in the context of particular embodiments may be combined or eliminated in other embodiments. Further, while advantages associated with certain embodiments have been described in the context of those embodiments, other embodiments may also exhibit such advantages. Not all embodiments need necessarily exhibit such advantages to fall within the scope of the present disclosure. Accordingly, the disclosure and the associated technology can encompass other embodiments not expressly shown or described herein.

I/We claim:

1. A rocket system, comprising:
a rocket body;
an engine carried by and movable relative to the rocket body; and
a seal assembly having:
a sealing surface carried by one of the rocket body and the engine;
a seal element carried by the other of the rocket body and the engine, the seal element being in contact with the sealing surface;
a cylinder; and
a piston slideably received in the cylinder, wherein one of the piston and the cylinder carries the seal element, and wherein an interior volume of the cylinder is in fluid communication with a region external to the rocket body.

2. The system of claim 1 wherein the cylinder has opposing generally flat, generally parallel cylinder walls, and wherein the piston has opposing generally flat, generally parallel piston walls.

3. The system of claim 1 wherein:
the cylinder is one of a plurality of elongated cylinders that together at least partially enclose an area;
the piston is one of a plurality of pistons, with individual pistons carried in corresponding cylinders, and with the individual pistons slideable relative to the corresponding cylinders along corresponding motion axes that converge toward each other; and
the seal element is carried by the plurality of pistons.

4. The system of claim 1 wherein the seal element includes a high-temperature ceramic material.

5. The system of claim 1 wherein the seal element includes a high-temperature wire braid wrapped around a ceramic material.

6. The system of claim 1 wherein the seal element forms a ring-shape that encloses an area.

7. The system of claim 6 wherein the area has an asymmetric shape.

8. The system of claim 1 wherein the seal element is a first seal element and wherein the system further comprises a second seal element positioned between an inwardly facing wall of the cylinder and an outwardly facing wall of the piston.

9. The system of claim 1 wherein the seal element has a sealing portion with a generally circular cross-sectional area and a generally round sealing surface, and a projection extending away from the sealing portion, the projection being clamped by the one of the piston and the cylinder.

10. A rocket system, comprising:
a rocket body separating an internal region from an external region;
an engine carried by the rocket body and positioned in the internal region of the rocket body, the engine having a nozzle that projects through the rocket body and is movable relative to the rocket body to direct engine thrust in multiple directions relative to the rocket body; and
a seal assembly having:
a generally spherical sealing surface carried by the rocket engine;
a flexible seal element carried by the rocket body, the flexible seal element being in contact with the sealing surface and having a continuous closed shape;
a plurality of cylinders carried by the rocket body;
a corresponding plurality of pistons connected to the flexible seal, with individual pistons slideably received in corresponding individual cylinders, wherein individual cylinders have ports in fluid communication with a region external to the rocket body to force the corresponding pistons outwardly from the cylinders and press the flexible seal against the spherical sealing surface when a pressure in the external region exceeds a pressure in the internal region.

11. The system of claim 10, further comprising a spring coupled between an individual cylinder and a corresponding individual piston to force the piston outwardly from the cylinder and press the flexible seal against the spherical sealing surface when a pressure in the external region is less than a pressure in the internal region.

12. The system of claim 10 wherein the closed shape of the seal is formed from a series of neighboring segments, and wherein the shapes of individual segments are formed by the intersection between a corresponding flat plane and the spherical surface, and wherein individual segments are driven by corresponding individual pistons.

13. The system of claim 10 wherein the spherical surface is a portion of a sphere having a sphere center, and wherein the pistons slide relative to the corresponding cylinders along radial actuation lines that converge at the sphere center.

14. The system of claim 10, further comprising a spring positioned to force the piston away from the cylinder.

15. A sealing system, comprising:
a plurality of elongated cylinders that together at least partially enclose an area;
a plurality of pistons, with individual pistons carried in corresponding cylinders, and with the individual pistons slideable relative to the corresponding cylinders along corresponding motion axes that converge toward each other; and
a flexible seal element carried by the plurality of pistons.

16. The system of claim 15 wherein the seal element includes a high-temperature ceramic material.

17. The system of claim 15 wherein the seal element includes a high-temperature wire braid wrapped around a ceramic material.

18. The system of claim 15 wherein the seal element forms a ring-shape that encloses the area, and wherein the seal element is positioned to at least partially seal against a spherical surface.

19. The system of claim 15 wherein the area has an asymmetric shape.

20. The system of claim 15, further comprising a generally spherical surface that is at least partially sealably engaged with the seal element.

21. A method for operating a rocket, comprising:
at least partially sealing an interface between a seal element and a sealing surface by forcing at least one of the seal element and the sealing surface against the other via pressure outside the rocket; and
maintaining the seal element in at least partially sealed contact with the sealing surface while moving a rocket engine relative to a body of the rocket, and while the seal element is carried by one of the rocket engine and the rocket body, and the sealing surface is carried by the other of the rocket engine and the rocket body.

22. The method of claim 21 wherein at least partially sealing an interface includes exposing a cylinder to the pressure outside the rocket, the cylinder slideably receiving a piston, at least one of the piston and the cylinder carrying the seal element.

23. The method of claim 21 wherein maintaining the seal element in at least partially sealed contact with the sealing surface includes maintaining the seal element to be at least partially sealed against a downwardly facing surface of the rocket while the rocket descends toward landing.

24. The method of claim 21 wherein moving the rocket engine includes gimbaling the rocket engine as the rocket lands, with thrust from the engine directed generally downwardly.

25. The method of claim 21 wherein maintaining the seal element in at least partially sealed contact with the sealing surface includes maintaining the seal element in at least partially sealed contact with a spherical sealing surface.

26. A method for operating a rocket, comprising:
exposing regions inside a plurality of cylinders of a seal assembly to a pressure external to the rocket, wherein individual cylinders slideably receive corresponding individual pistons;
forcing the individual pistons outwardly relative to the corresponding individual cylinders;
forcing a flexible seal member carried by the individual pistons against a spherical sealing surface carried by an engine of the rocket; and
while the flexible seal is forced against the sealing surface, moving the rocket engine relative a body of the rocket so as to redirect rocket thrust provided by the engine.

27. The method of claim 21 wherein forcing the individual pistons outwardly includes forcing the individual pistons along corresponding, converging axes.

28. The method of claim 21 wherein moving the rocket engine includes gimbaling the rocket engine as the rocket lands, with thrust from the engine directed generally downwardly.
